(19) United States
(12) Patent Application Publication
(10) Pub. No.: US 2007/0052742 A1
(43) Pub. Date: Mar. 8, 2007

(54) Color filter manufacturing apparatus, medium, and method with scheduled printing

(75) Inventor: Bang Weon Lee, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/432,540

(22) Filed: May 12, 2006

(30) Foreign Application Priority Data
Sep. 8, 2005 (KR) 10-2005-0083740

(51) Int. Cl. B41J 29/38

(52) U.S. Cl. 347/9

(57) ABSTRACT

A color filter manufacturing apparatus, method, and medium ink-jet printing through an ink-jet period schedule of heads, in which one head driver or a plurality of head drivers generate an ink-jet control signal for each head in accordance with the schedule data, with the heads being provided on a head array to jet ink in accordance with the corresponding ink-jet control signal with a predetermined ink-jet frequency.

### CROSS-REFERENCE TO RELATED APPLICATIONS

This application claims the benefit of Korean Application No. 10-2005-0083740, filed Sep. 8, 2005, in the Korean Intellectual Property Office, the disclosure of which is incorporated herein by reference.

### BACKGROUND OF THE INVENTION

1. Field of the Invention

FIG. 1 illustrates a general thin film transistor-liquid crystal display (TFT-LCD) panel 100 with a color filter. The TFT-LCD panel 100 can be used to receive and display image data on a general TFT-LCD so that a user can see a certain image, and may be applicable to all devices displaying a certain image, such as cellular phones, digital cameras, computer screens, television screens, and the like, for example. The color filter enables the TFT-LCD panel 100 to produce different colors from a single color back light.

2. Description of the Related Art

Here, the TFT-LCD panel 100 may include a lower plate 110 and an upper plate 120 with a plurality of electrodes to generate an electric field, with liquid crystal layer being provided between the lower plate 110 and the upper plate 120. Also, to polarize light the TFT-LCD panel 100 may also include polarizing plates attached to the lower plate 110 and the upper plate 120. The brightness of light may be controlled by supplying power, on the basis of a gray scale, to a pixel electrode to rearrange liquid crystal molecules. To achieve this, a plurality of switching devices such as thin film transistors (TFT) may be connected to pixel electrodes provided on the lower plate 110 of the TFT panel 100, and may be switched to supply the gray scale voltages to the pixel electrodes. The color filter may be made up of cells colored in red (R), green (G), and blue (B), for example, for each pixel is provided on the upper plate 120 of the TFT-LCD panel 100. In addition, a black matrix may be provided between cells of a color filter pattern to veil inner parts, such as a gate line or source line, TFT of the lower plate 110, and the like.

To manufacture a color filter, as described above, generally, a black matrix is first prepared on a substrate, and a process of spreading, exposing and developing photo resist (hereinafter, PR) is then performed. However, the method as described above has ineffective aspects, such as the process resulting in very long manufacturing times and the wasting of materials. Accordingly, an ink-jet printing method is currently being developed. The ink-jet printing method is a process which progresses by printing each color filter cell R, G, and B just like drawing a picture on a paper, without the previously required patterning process for removing PR. Accordingly, since the process itself is simplified, a large portion of the manufacturing time can be reduced and materials can be saved.

As illustrated in FIG. 2, one ink jet head can be used to jet the same color ink drops into filter cells with the same color, with the color red (R) being illustrated. However, this described process of using one head requires the one head to jet ink while scanning every cell in succession, in order to complete one color filter. Accordingly, with this singular head approach more manufacturing time is required.

As illustrated in FIG. 3, a head array with a plurality of ink jet heads may be used. Here, nozzles are provided on a head array to jet ink and are arranged with a pitch ranging from hundreds of micrometers to millimeters, for example. From this arrangement of nozzles, correspondingly colored ink drops are jetted to exact positions of filter cells for each column, until all filter cells have been generated.

Thus, in a normal process, it is possible to print ink to a corresponding position on a glass substrate without tilting the head array. However, in this normal process, positions of nozzles, for jetting ink drops with the same color, cannot be substantially different from the actual positions of filter cells. Thus, for each manufacturing process a particular head array with a particular nozzle pitch may have to be generated such that the nozzles of the generated head array match up with positions of filter cells. Thus, a new array may need to be generated each time a desired resolution or orientation of positions of filter cells changes.

In this normal process, the number of nozzles jetting an ink drop with the same color is comparatively small. Accordingly, it takes a long time to manufacture a color filter. To overcome this drawback, as illustrated in FIG. 4, the head array may be tilted with respect to a glass substrate, e.g., between about θ1->θ2, such that the number of nozzles jetting an ink drop with the same color to the same filter cell may be increased. Accordingly, the method of tilting a head array is frequently used to reduce the total time needed to manufacture a color filter.

However, compared with the non-tilting normal method, in the tilting method the space occupied by a head array to scan the whole glass substrate is greater. Also, in the tilting method, great effort is needed to set the tilting angle before starting to manufacture a color filter. In this instance, in the method of setting a tilting angle, it may be similarly impossible to manufacture color filters for all resolutions by using the same head array. In other words, it is not easy to set up a stabilized process by merely tilting a head array and setting a tilting angle such that a plurality of nozzles can jet ink drops in same color. Also, although the process may have been set up for one panel, when a pixel pitch is changed, e.g., in accordance with a change of a resolution of a TFT-LCD panel, a corresponding different panel may not be available through a mere changing of the tilting of the head array. In this case, even in the tilting method, a corresponding head array may have to be re-manufactured.

### SUMMARY OF THE INVENTION

To solve at least the aforementioned problems, embodiments of the present invention include a color filter manufacturing apparatus and method where an ink jet head array is arranged in the lengthwise direction of a pixel and each head provided on the ink jet head array prints in accordance with schedule data with respect to ink jet time. According to embodiments of the present invention, manufacturing times may be reduced and head arrays may be used semi-permanently.

To achieve the above and/or other aspects and advantage, embodiments of the present invention include a manufacturing apparatus, for color filter manufacturing, including a head array including a plurality of heads, with each of the plurality of heads including a plurality of nozzles, selectively jetting drops for each respective nozzle to respective drop positions on a surface, in accordance with schedule data, wherein the schedule data aligns a timing of selective nozzle jetting with anticipated positioning of respective drop positions on the surface.

The apparatus may further include a storage unit storing the schedule data.

The schedule data may further include selective jetting frequencies for each respective nozzle in a respective head. The aligning of the timing of selective nozzle jetting may include different nozzles in different heads operating at different times. In addition, the aligning of the timing may include taking into consideration movement between the surface and the head array. Here, the movement between the surface and the head array may be with the head array being aligned in an orientation without an inclination relative to a pitch between drop positions. Further, the movement may be a movement of the surface past a fixed position of the head array, at a predetermined velocity.

The apparatus may include a head driver generating a jet control signal for each head corresponding to the schedule data to control jetting by each corresponding head. The head driver may generate the jet control signal for each head corresponding to separate schedule data for each respective head.

The head array may jet ink drops from the plurality of heads provided in the lengthwise direction of color filter cells of the surface. The head array may jet different colored ink drops from different color producing heads.

The schedule data may be based on positions of respective nozzles of respective heads of the head array and corresponding drop position for corresponding filter cells on a glass substrate, as the surface, and the filter cells are color filter cells.

Each respective head may jet ink from a starting jet position for a first corresponding head to a jet position, for a color filter cell, where a second corresponding head neighboring the corresponding first head previously started jetting an ink drop. At least five drops may be jetted within each color filter cell.

In addition, first heads provided having drop positions aligned with respective nozzles of the first heads, among drop positions on the surface for corresponding color filter cells, may simultaneously jet. Second heads, not simultaneously jetting with the first heads, may delay corresponding simultaneous jetting until the second heads are transferred, through movement of the head array or surface, as far as a distance gap between a corresponding nozzle of a second head and an alignment with a next corresponding drop position on the surface nearest to the corresponding nozzle of the second head.

Each second head may jet to a drop position that is separated from the next corresponding nearest drop position according to a pitch for drop positions, when a delay for a corresponding distance gap is greater than a period to receive corresponding schedule data from a head driver generating jetting control signals for each head.

The head array may include a set of arrays of heads, each array for separate color filter cells for a first color, a second color, and a third color, respectively, and heads for each respective array, for each color filter cell, may jet in accordance with a corresponding ink-jet control signal generated by a head driver generating jetting control signals for each head.

The first color may be red (R), the second color may be green (G), and the third color may be blue (B), and the color filter cells for each color may be printed in a stripe having a consistent color in a lengthwise direction of each cell. Similarly, the first color may be red (R), the second color may be green (G), and the third color may be blue (B), and the color filter cells for each color may be printed in a triangle arrangement.

To achieve the above and/or other aspects and advantage, embodiments of the present invention include a color filter manufacturing apparatus including a storage unit to store a plurality of schedule data about ink jets for a plurality of heads, a plurality of head drivers to generate an ink-jet control signal corresponding to each of the plurality of schedule data, and a head array including the plurality of heads, with each of the plurality of heads jetting ink drops to a surface in accordance with a corresponding ink-jet control signal output from each of the plurality of head drivers.

The head array may jet ink drops from the plurality of heads, the heads being provided in a lengthwise direction of a color filter cell on the surface.

Heads, having nozzles aligned with drop positions, may simultaneously jet ink drops to respective drop positions for color filter cells on a glass substrate, as the surface, and heads, having nozzles not aligned with drop positions, simultaneously jet ink to a respective next drop position after being first transferred a distance gap between a corresponding nozzle and the respective next drop position nearest to the corresponding nozzle, on the glass substrate.

To achieve the above and/or other aspects and advantage, embodiments of the present invention include a manufacturing method, for manufacturing a color filter using a head array having a plurality of heads, the method including obtaining schedule data aligning a timing of selective nozzle jetting of respective heads with anticipated positioning of respective drop positions on a surface, and selectively jetting, for each respective nozzle, to the respective drop positions on the surface, in accordance with the schedule data.

The schedule data may include selective jetting frequencies for each respective nozzle in a respective head. In addition, the aligning of the timing of selective nozzle jetting may include different nozzles in different heads operating at different times. The aligning of the timing may include taking into consideration movement between the surface and the head array. The movement between the surface and the head array may be with the head array being aligned in an orientation without an inclination relative to a pitch between drop positions. Further, the movement may be a movement of the surface past a fixed position of the head array, at a predetermined velocity.

The method may further include the generating of a jet control signal for each head corresponding to the schedule data to control jetting of each respective head. The generating of the jet control signal for each head may include utilizing separate schedule data for each respective head.

The method may still further include the receiving of the schedule data from a storage unit. The plurality of heads may jet ink drops in the lengthwise direction of color filter cells of the surface.

The schedule data may be based on positions of respective nozzles of respective heads of the head array and corresponding drop positions for corresponding color filter cells on a glass substrate, as the surface, and the schedule data may be processed by one head driver to generate ink-jet control signals for each respective head to control jetting of ink for each respective head. Each respective head may jet ink from a starting jet position for a first corresponding head to a jet position, for a color filter cell, where a second corresponding head neighboring the corresponding first head previously started jetting an ink drop.

At least five drops are jetted within each color filter cell. In addition, first heads provided having drop positions aligned with respective nozzles of the first heads, among drop positions on the surface for corresponding color filter cells, may simultaneously jet. Second heads, not simultaneously jetting with the first heads, may delay corresponding simultaneous jetting until the second heads are transferred, through movement of the head array or surface, as far as a distance gap between a corresponding nozzle of a second head and an alignment with a next corresponding drop position on the surface nearest to the corresponding nozzle of the second head.

Each second head may jet to a drop position that is separated from the next corresponding nearest drop position according to a pitch for drop positions, when a delay for a corresponding distance gap is greater than a period to receive corresponding schedule data for generating an ink-jet control signal of each head to control jetting of each head.

The head array may include a set of arrays of heads for separate color filter cells for a first color, a second color, and a third color, respectively, and heads for each respective array, for each color filter cell, may jet in accordance with a corresponding ink-jet control signal. The first color may be red (R), the second color may be green (G), and the third color may be blue (B), and the color filer cells for each color may be printed in a stripe having a same consistent color in a lengthwise direction of each cell. Similarly, the first color may be red (R), the second color may be green (G), and the third color may be blue (B), and the color filter cells for each color may be printed in a triangle arrangement.

Each of the plurality of schedule data may be processed by each of the plurality of head drivers and the ink-jet control signal of each head may be generated.

Heads, having nozzles aligned with drop positions, may simultaneously jet ink drops to respective drop positions for color filter cells on a glass substrate, as the surface, and heads, having nozzles not aligned with drop positions, may simultaneously jet ink to a respective next jet position after being first transferred a distance gap between a corresponding nozzle and the respective next jet position nearest to the corresponding nozzle, on the glass substrate.

To achieve the above and/or other aspects and advantage, embodiments of the present invention include a medium including computer readable code to implement methods according to embodiments of the present invention.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a general TFT-LCD panel with a color filter;

FIG. 2 illustrates a color filter manufacturing method using one head;

FIG. 3 illustrates a color filter manufacturing method using a tilted head array;

FIG. 4 illustrates how different tilting angles of a head array affect manufacturing of a color filter;

FIG. 5 illustrates a color filter manufacturing apparatus, according to an embodiment of the present invention;

FIG. 6 illustrates a manufacturing process of jetting ink onto a glass substrate via a head array, according to an embodiment of the present invention;

FIG. 7 illustrates a manufacturing process for a color filter manufacturing apparatus, such as that of FIG. 5, according to an embodiment of the present invention;

FIG. 8 illustrates a manufacturing process for a color filter based on a schedule with respect to ink jet time of a head array, according to an embodiment of the present invention;

FIG. 9 illustrates a color filter manufacturing apparatus, according to another embodiment of the present invention;

FIG. 10 illustrates an ink jet method performed by a set of arrays for three respective colors, according to an embodiment of the present invention; and

FIG. 11 illustrates an ink jet method for a color filter where color filter cells are in a triangle or delta ∇ arrangement on a substrate, according to an embodiment of the present invention.

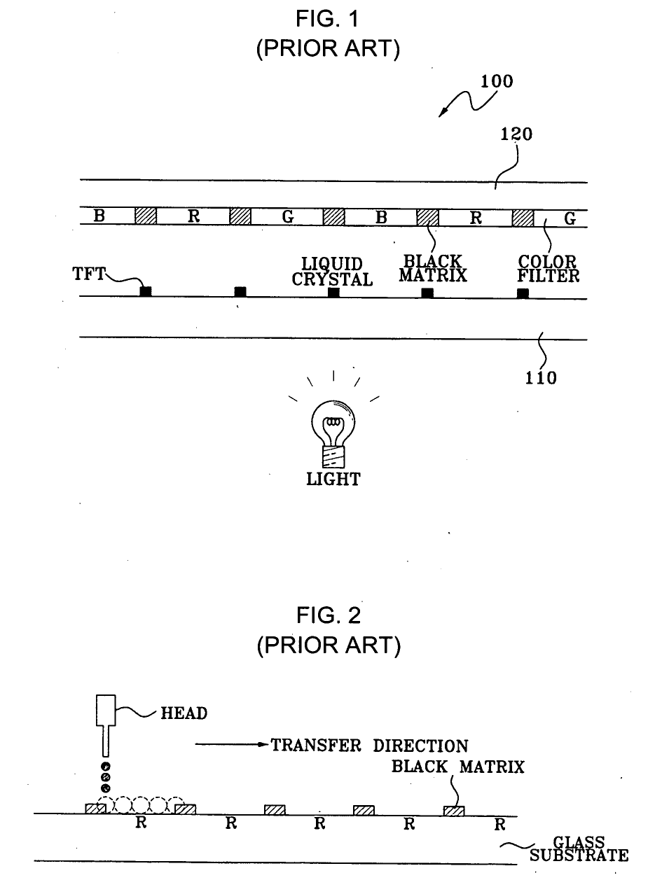

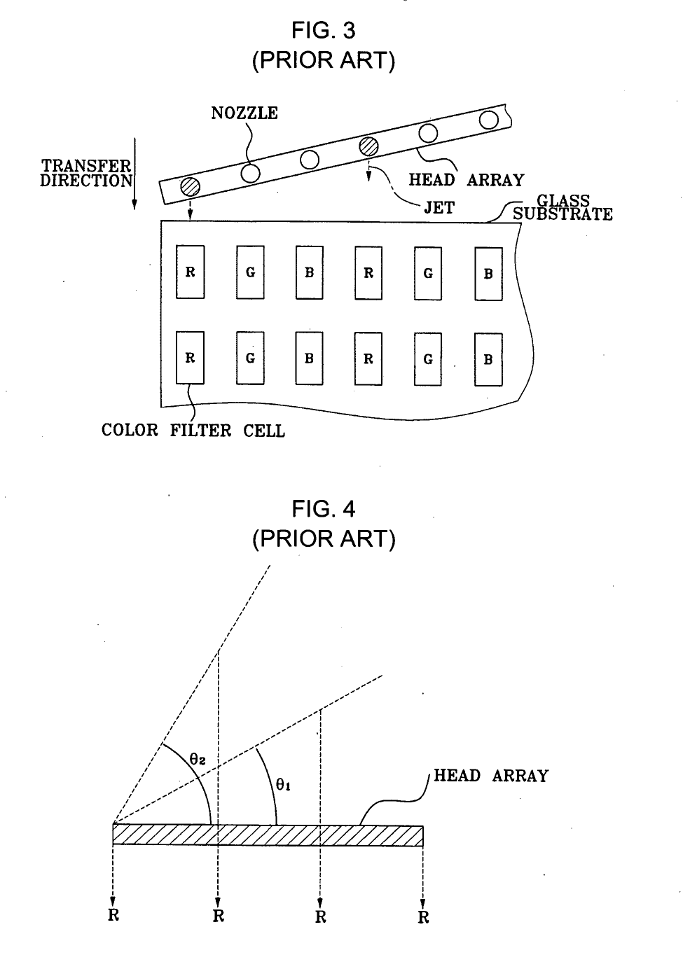

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

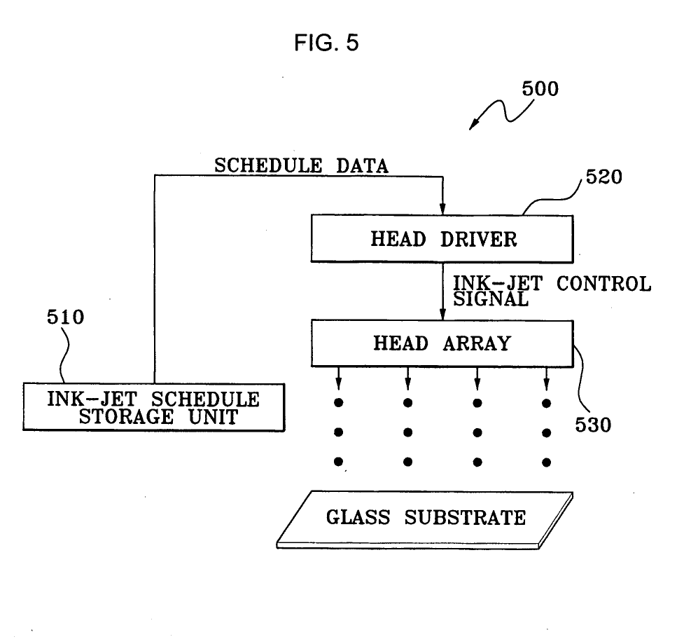

FIG. 5 illustrates a color filter manufacturing apparatus 500, according to an embodiment of the present invention. Referring to FIG. 5, the color filter manufacturing apparatus 500 may include an ink-jet schedule storage unit 510, a head driver 520, and a head array 530, for example.

As discussed herein, the color filter manufacturing apparatus 500 has been shown to be applicable for the manufacturing of a color filter, such as that for a TFT-LCD panel for a cellular phone, a digital camera, a computer screen or a television screen, and the like, for example. Although the color filter manufacturing apparatus 500 can print color filter cells, using an ink jet printing method, for such screens, alternative embodiments implementing the invention herein are equally available.

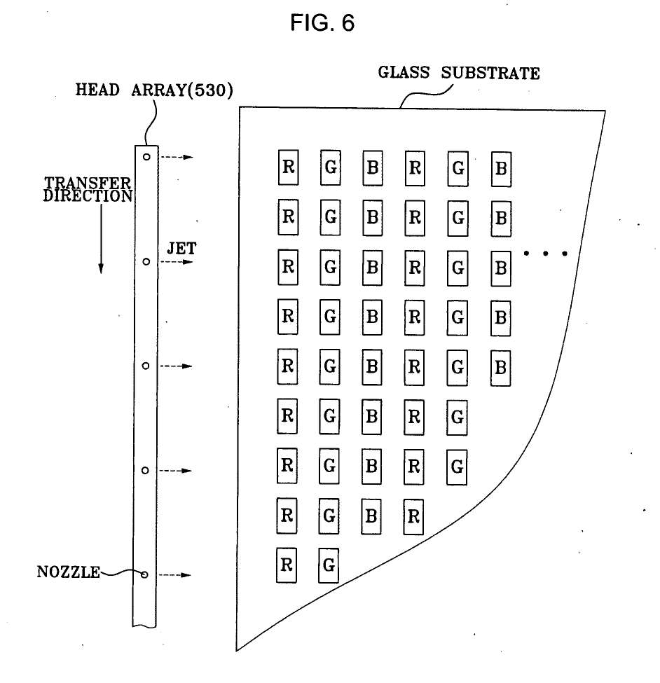

As illustrated in FIG. 6, according to an embodiment of the present invention, the head array 530 may be driven by the head driver 520 to jet an ink drop while the head array 530 is vertically aligned with a pixel position of a TFT-LCD panel, i.e., a color filter cell on the panel where ink will be printed to generate the color filter. Accordingly, as there is no tilting of the head array 530 in this embodiment, the required space occupied by the head array to implement the process becomes smaller than the conventional tilting processes. In particular, according to this embodiment, there is no need to repeatedly scan an area of glass substrate since the jetting of ink to the color filter cells is accomplished through schedule data from the ink-jet schedule storage unit 510, downloaded to the head driver 520. Through implementation of embodiments of the present invention there is no need for remanufacturing the head array 530, even when the resolution of the TFT-LCD panel is changed, since all the color filter resolutions may be manufactured by correcting only the schedule data with respect to ink jet time.

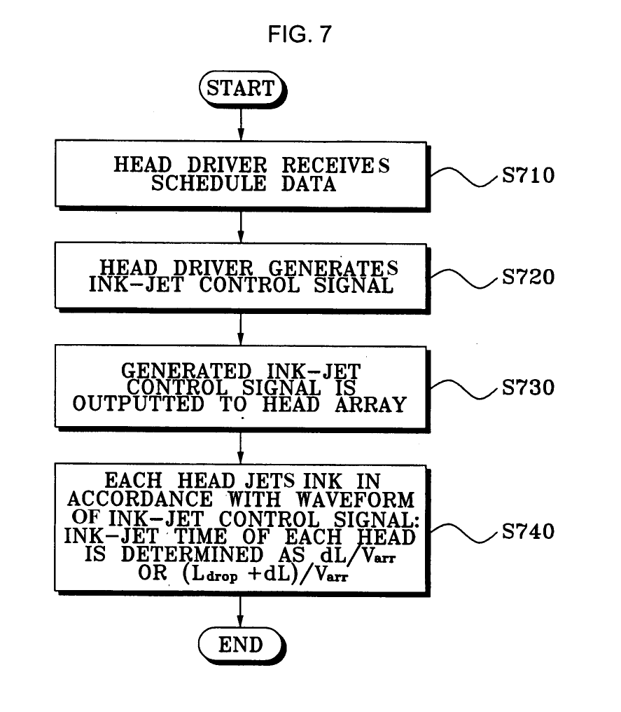

According to an embodiment of the present invention, an operation of a color filter manufacturing apparatus, such as the color filter manufacturing apparatus 500 in FIG. 5, will be described below with reference to FIG. 7.

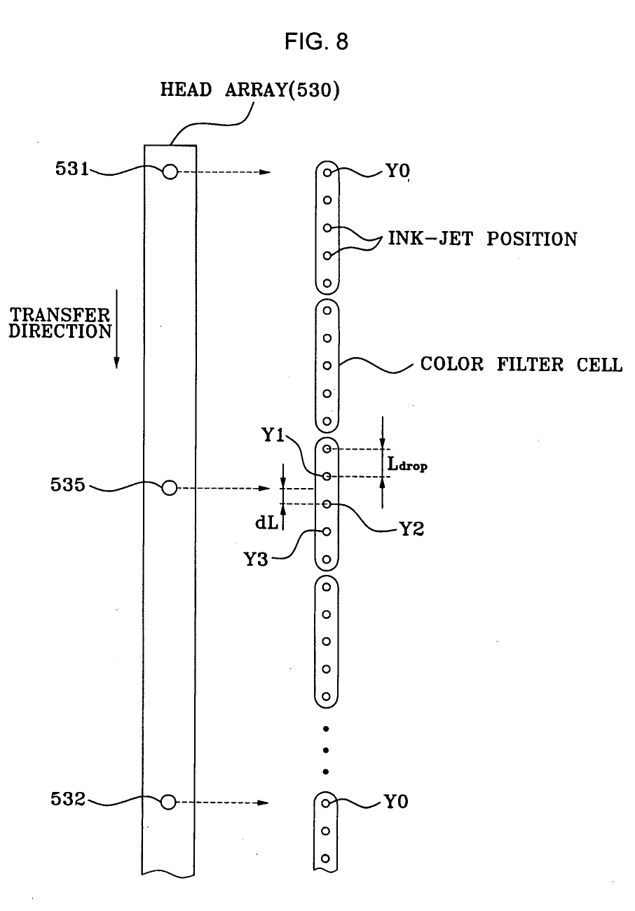

The ink-jet schedule storage unit 510 may store a plurality of schedule data about ink jets of the head array 530. According to an embodiment of the present invention, the plurality of schedule data stored in the ink-jet schedule storage unit 510 will be described further below in greater detail with reference to FIG. 8.

In operation S710, the head driver 520 may sequentially receive the plurality of schedule data from the ink-jet schedule storage unit 510. The head driver 520 may generate an ink-jet control signal for each head, corresponding to each of the plurality of received schedule data, in operation S720. The generated ink-jet control signal for each head may be output to each of a plurality of heads provided on the head array 530, for example, in operation S730. Each of the plurality of heads provided on the head array 530 can jet ink drops on a glass substrate at fixed times, in accordance with a corresponding ink-jet control signal output from the head driver 520, in operation S740. In this instance, it may be assumed that a black matrix has already been formed between color filter cells on the glass substrate, before ink drops are jetted on the glass substrate from the plurality of heads of the head array 530, for example.

Here, as illustrated in FIG. 6, each of the plurality of heads of the head array 530 may jet the ink drops via corresponding nozzle(s) when the head array 530 is vertically aligned with a corresponding color filter cell. Here, it is noted that it may take a certain amount of time, such as about 30 microseconds, for the head driver 520 to download one schedule data from the ink-jet schedule storage unit 510, and it further may take a certain amount of time, such as about 20 micro seconds, for the head driver 520 to generate an ink-jet control signal for each corresponding head from the received schedule data. As described above, the head driver 520 may repeat the receiving of schedule data from the ink-jet schedule storage unit 510 and generating of an ink-jet control signal for each head. In this instance, each of the plurality of heads of the head array 530 may jet ink drops on the glass substrate, for example, in accordance with a corresponding ink-jet control signal. Also, as an example, 5 to 7 drops of ink may have to be jetted at a corresponding cell position to print one color filter cell. For this, as illustrated in FIG. 6, the glass substrate or the head array 530 may be transferred, in the lengthwise direction of color filter cells, at a certain speed Vₐᵣᵣ by a transfer instrument (not shown). In this instance, each of the plurality of heads of the head array 530 may jet ink on the glass substrate in accordance with a certain ink-jet frequency from the point in time when jetting starts.

To manufacture a color filter fitting a resolution of a TFT-LCD panel, for example, a position of the jetted ink on a glass substrate may be determined as a standard of a pixel array based on the resolution. Thus, to print all corresponding color filter cells positioned in a scanned area, while the head array 530 scans the area once in the transfer direction, head nozzles aligned with matching color filter cells on the substrate, e.g., nozzles of the plurality of heads provided on the head array 530, may simultaneously jet ink to a glass substrate for each color filter cell.

FIG. 8 illustrates a manufacturing process for a color filter based on a schedule with respect to ink jet time of a head array, according to an embodiment of the present invention.

The plurality of schedule data, stored in the ink-jet schedule storage unit 510, for example, may be based on a position of each nozzle of the plurality of heads, provided on the head array 530, and ink-jet drop positions for a corresponding color filter cell, e.g., on a glass substrate. As an example, when there is a lateral gap between ink-jet drop positions on the glass substrate and nozzles of the plurality of heads, that gap may be determined/measured. Then the schedule data may be generated such that such heads of the head array 530 that have an identical distance gap can be scheduled to simultaneously drive, to thereby drop ink upon the desired ink-jet drop positions. Similarly, when the nozzles of alternate heads are already aligned with the desired ink-jet drop positions the schedule data for those alternate heads, i.e., matching heads, can be set to simultaneously drive those heads to drop ink upon those desired ink-jet drop positions. Thus, matching heads differ from un-matched heads in that the driving of the respective heads must be delayed until nozzles of each head are vertically aligned with respective ink-jet drop positions.

Accordingly, in the operations S710 and S720 of FIG. 7, the head driver 520 may receive the schedule data, e.g., in succession, and generate an ink-jet control signal for each head. The ink-jet control signal of each head, which may be a certain waveform, is indicative of the position where ink will be jetted in accordance with corresponding schedule data. As an example, the ink-jet control signal for each head may be formed to have a pulse with a desired ink-jet frequency, e.g., to jet a sufficient amount of ink to each desired color filter cell.

According to an embodiment of the present invention, when the generated ink-jet control signal of each head is output to the head array 530, in operation S730, the head array 530 and/or the glass substrate may be transferred in a lengthwise direction, for example, of color filter cells at a certain speed Vₐᵣᵣ. Accordingly, heads located over positions Y0 with matching (aligned) nozzles may simultaneously start jetting an ink drop via corresponding nozzles 531 and 532, for example, with a certain ink-jet frequency, in operation S740 of FIG. 7. The number of heads provided on the head array 530 and the number of nozzles of each head may be in the hundreds, e.g., a head may include 128 nozzles. In this case, nozzles of heads not oriented over desired ink-jet drop positions may first be delayed for the distance gap dL between the corresponding nozzle 535 and the next nearest ink-jet drop position Y2 on the glass substrate (e.g., dL/Vₐᵣᵣ) and after such a delay subsequently simultaneously start jetting an ink drop in according to a certain ink-jet frequency. In this instance, as illustrated in FIG. 8, each of the plurality of heads, for example, head 531, jets ink drops to position Y0 to position Y1, which is just before ink-jet drop position Y2 of a color filter cell where a nozzle of a neighboring head, for example, the head 535, jets corresponding ink drops along a different schedule or timing.

According to an embodiment of the present invention, as the glass substrate and/or the head array 530 is transferred in a lengthwise direction of the color filter cells, where the distance gap dL between the nozzle 535 and the next ink-jet position Y2 is small, heads provided in orientations where corresponding nozzles do not match desired ink drop positions start jetting ink drops at a position Y3, wherein position Y3 is separated from ink-jet position Y2 by a small pitch of L_{drop}. In this situation, Y3 is the first ink-jet drop position for the corresponding head because the nozzle 535 of the corresponding head does not normally jet ink at the ink-jet position Y2 when the transfer period for the distance gap dL is shorter than the period (time needed) to receive corresponding schedule data from the head driver 520 and/or generate an ink-jet control signal of each corresponding head. For example, such a transfer period could be shorter than 50 microseconds. In this example, it may be expected that a waveform of a corresponding ink-jet control signal may not be normally generated at the head driver 520, and voltage supplied to a corresponding head may be insufficient. In this case, the nozzle 535 of the head may first be delayed until the inkjet position Y3 (dL+L_{drop})/Vₐᵣᵣ and then start jetting an ink drop. Again, here, the ink-jet position Y3 may be a position that may be separated from the nearest ink-jet position to a non-matching nozzle according to a pitch L_{drop} of ink-jet positions of the ink drops on the glass substrate.

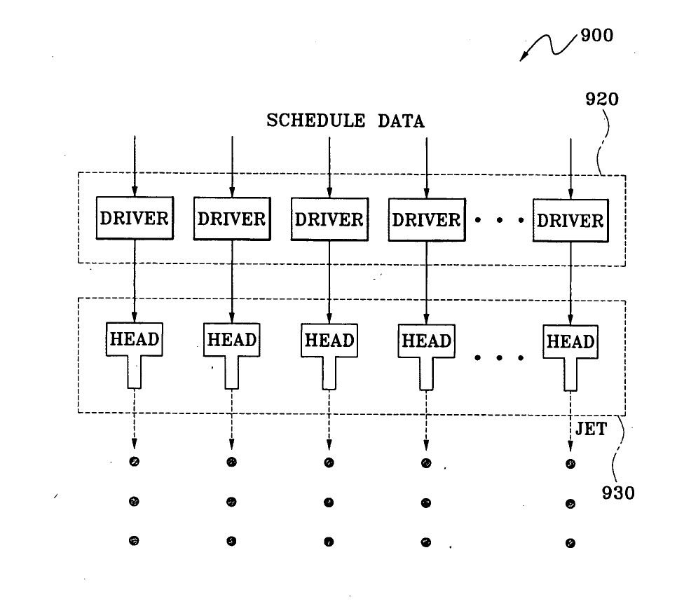

FIG. 9 illustrates a color filter manufacturing apparatus 900, according to another embodiment of the present invention. Referring to FIG. 9, the color filter manufacturing apparatus 900 may include a plurality of head drivers 920. Here, each head driver 920 may drive a corresponding individual head on a head array 930.

As noted in FIG. 5, one head array 520 may have to drive a plurality of heads provided on the head array 530. Accordingly, the head driver 520 may have to repeat the receiving of schedule data and generating of corresponding ink-jet control signals based of the comparative distance gaps between nozzles of the plurality of heads and corresponding ink-jet drop positions on the glass substrate. In this instance, the schedule data may be respectively different. However, as illustrated in FIG. 9 and according to another embodiment of the present invention, a plurality of head drivers 920 may be used to reduce the burden of the head driver 520.

Here, each of the plurality of head drivers 920 may receive corresponding schedule data from a memory such as the ink-jet schedule storage unit 510, shown in FIG. 5, for example, storing a plurality of schedule data, and generate an ink-jet control signal corresponding to the received schedule data. In this case, the schedule data may be based on the comparative distance gap between nozzles of the plurality of heads of the head array 930 and ink-jet drop positions on the glass substrate.

In addition, each of the plurality of heads of the head array 930 may start jetting ink drops at fixed times, in accordance with a corresponding ink-jet control signal output from each of the plurality of head drivers 920. In this case, the head array 930 may jet the ink drops via the plurality of heads in accordance with a certain ink-jet frequency, when nozzles of the head array 930 is vertically aligned with color filter cells. Each of the plurality of head drivers 920 may first be transferred a length of the head array 930 and then repeat jetting of the ink drops in accordance with the same schedule data, for example.

Similar to the head array 530 in FIG. 5, heads in positions with matching/aligned nozzles of the plurality of heads on the head array 930 may simultaneously start jetting ink drops. In this instance, each unmatched/non-aligned head may first be transferred as far as the length of the distance gap between a corresponding nozzle and a next ink drop position on the glass substrate nearest to the nozzle, and subsequently jet ink drops.

Here, each of the plurality of head drivers 920 may not download schedule data again until all areas on the glass substrate have been printed. Accordingly, it may not be unnecessary to consider whether transfer period (dL/Vₐᵣᵣ) for the distance gap dL of FIG. 8 is shorter than the period needed to receive corresponding schedule data from the head drivers 920 and/or generate an ink-jet control signal of each head.

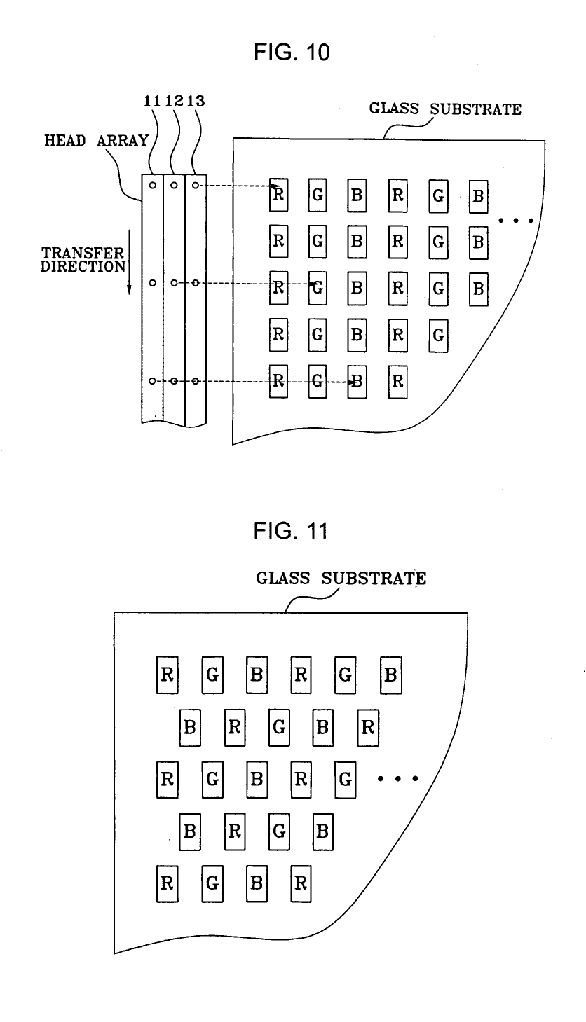

FIG. 10 illustrates an ink jet method, according to an embodiment of the present invention, performed through a set of arrays formed of three colors, for example. Referring to FIG. 10, the head arrays in FIGS. 5 and 9 may be a head array set including a first array 13, e.g., for color filter cells for the color red (R), a second array 12, for color filter cells for the color green (G), and a third array 11, e.g., for color filter cells for the color blue (B). In this instance, heads provided on each array, for color filter cells of each corresponding color, may jet ink drops in corresponding colors at fixed times in accordance with ink-jet control signals for each array, e.g., output from the head driver 520 or 920.

As illustrated in FIGS. 6, 8, and 10, here, it may be assumed that color filter cells of each color are printed in a stripe type having the same color pattern in the lengthwise direction of each cell, noting that alternative embodiments are equally available. For example, embodiments of the present invention may be applicable to a color filter having a triangular/delta ∇ arrangement, such as illustrated in FIG. 11. Those of ordinary skills in the related art may make corresponding schedule data of a color filter of a triangular type from standards such as the size of color filter cells, the size of a black matrix, a horizontal and vertical pitch of a cell, and the like, for example, similar to a color filter of a stripe type.

As described above, in the color filter manufacturing apparatuses 500 and 900, according to embodiments of the present invention, the head driver 520 and the plurality of head drivers 920 may generate an ink-jet control signal for each head according to schedule data. Heads provided on the head arrays 530 and 930 may jet ink with a certain ink-jet frequency, at fixed times, according to a corresponding ink-jet control signal, for example.

As further described above, an embodiment of the present invention includes a color filter manufacturing apparatus and method where each head of an ink-jet head array prints to respective color filter cells in the lengthwise direction of pixels on a glass substrate, in accordance with schedule data the for ink-jet printing. Accordingly, according to an embodiment of the preset invention, since it is unnecessary to re-scan an already scanned area of a glass substrate for complete coverage of the glass substrate, it is possible to save processing time over conventional systems. Similarly, according to an embodiment of the present invention, since there is no need for the tilting of the head array, it is possible to reduce the space required to implement the printing to the glass substrate. In addition, while the desired resolution of a TFT-LCD panel may change, the underlying hardware, such as a head array or the like, does not have to be changed when manufacturing a corresponding color filter, compared to conventional systems where new hardware must be manufactured. Here, it is possible to manufacture all color filters by using one head array, for example, by correcting only schedule data.

In addition to the above, embodiments of the present invention may also be implemented through a computer readable code, e.g., a program instruction, which can be embodied in various devices and recorded/transferred through a medium, e.g., a computer readable recording medium. Media may include, alone or in combination with the computer readable code, data files, data structures, tables, and the like, for example. The media may include those specially designed and constructed for the purposes of embodiments of the present invention, or may be of the kind well known and available to those having skill in the computer software arts, for example. Examples of media include: magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM), for example. The media may also be a transmission medium such as optical or metallic lines, wave guides, etc., including a carrier wave transmitting computer readable code, data structures, etc. Examples of computer readable code include both machine code, such as produced by a compiler, and files containing higher level code that may be executed by the computer using an interpreter, as well as singular instructions. The above hardware elements may also be configured to act as/with one or more computer readable code modules implementing operations of the present invention.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A manufacturing apparatus, for color filter manufacturing, comprising:
a head array comprising a plurality of heads, with each of the plurality of heads comprising a plurality of nozzles, selectively jetting drops for each respective nozzle to respective drop positions on a surface, in accordance with schedule data,
wherein the schedule data aligns a timing of selective nozzle jetting with anticipated positioning of respective drop positions on the surface.

2. The apparatus of claim 1, further comprising a storage unit storing the schedule data.

3. The apparatus of claim 1, wherein the schedule data includes selective jetting frequencies for each respective nozzle in a respective head.

4. The apparatus of claim 1, wherein the aligning of the timing of selective nozzle jetting includes different nozzles in different heads operating at different times.

5. The apparatus of claim 1, wherein the aligning of the timing includes taking into consideration movement between the surface and the head array.

6. The apparatus of claim 5, wherein the movement between the surface and the head array is with the head array being aligned in an orientation without an inclination relative to a pitch between drop positions.

7. The apparatus of claim 5, wherein the movement is a movement of the surface past a fixed position of the head array, at a predetermined velocity.

8. The apparatus of claim 1, further comprising a head driver generating a jet control signal for each head corresponding to the schedule data to control jetting by each corresponding head.

9. The apparatus of claim 8, wherein the head driver generates the jet control signal for each head corresponding to separate schedule data for each respective head.

10. The apparatus of claim 1, wherein the head array jets ink drops from the plurality of heads provided in the lengthwise direction of color filter cells of the surface.

11. The apparatus of claim 10, wherein the head array jets different colored ink drops from different color producing heads.

12. The apparatus of claim 1, wherein the schedule data is based on positions of respective nozzles of respective heads of the head array and corresponding drop position for corresponding filter cells on a glass substrate, as the surface, and the filter cells are color filter cells.

13. The apparatus of claim 12, wherein each respective head jets ink from a starting jet position for a first corresponding head to a jet position, for a color filter cell, where a second corresponding head neighboring the corresponding first head previously started jetting an ink drop.

14. The apparatus of claim 13, wherein at least five drops are jetted within each color filter cell.

15. The apparatus of claim 14, wherein first heads provided having drop positions aligned with respective nozzles of the first heads, among drop positions on the surface for corresponding color filter cells, simultaneously jet.

16. The apparatus of claim 15, wherein second heads, not simultaneously jetting with the first heads, delay corresponding simultaneous jetting until the second heads are transferred, through movement of the head array or surface, as far as a distance gap between a corresponding nozzle of a second head and an alignment with a next corresponding drop position on the surface nearest to the corresponding nozzle of the second head.

17. The apparatus of claim 16, wherein each second head first jets to a drop position that is separated from the next corresponding nearest drop position according to a pitch for drop positions, when a delay for a corresponding distance gap is smaller than a period to receive corresponding schedule data from a head driver generating jetting control signals for each head.

18. The apparatus of claim 1, wherein:
the head array comprises a set of arrays of heads, each array for separate color filter cells for a first color, a second color, and a third color, respectively, and heads for each respective array, for each color filter cell, jet in accordance with a corresponding ink-jet control signal generated by a head driver generating jetting control signals for each head.

19. The apparatus of claim 18, wherein:
the first color is red (R), the second color is green (G), and the third color is blue (B), and
the color filter cells for each color are printed in a stripe having a consistent color in a lengthwise direction of each cell.

20. The apparatus of claim 18, wherein:
the first color is red (R), the second color is green (G), and the third color is blue (B), and
the color filter cells for each color are printed in a triangle arrangement.

21. A color filter manufacturing apparatus comprising:
a storage unit to store a plurality of schedule data about ink jets for a plurality of heads;
a plurality of head drivers to generate an ink-jet control signal corresponding to each of the plurality of schedule data; and
a head array comprising the plurality of heads, with each of the plurality of heads jetting ink drops to a surface in accordance with a corresponding ink-jet control signal output from each of the plurality of head drivers.

22. The apparatus of claim 21, wherein the head array jets ink drops from the plurality of heads, the heads being provided in a lengthwise direction of a color filter cell on the surface.

23. The apparatus of claim 21, wherein:
heads, having nozzles aligned with drop positions, simultaneously jet ink drops to respective drop positions for color filter cells on a glass substrate, as the surface, and
heads, having nozzles not aligned with drop positions, simultaneously jet ink to a respective next drop position after being first transferred a distance gap between a corresponding nozzle and the respective next drop position nearest to the corresponding nozzle, on the glass substrate.

24. A manufacturing method, for manufacturing a color filter using a head array having a plurality of heads, the method comprising:
obtaining schedule data aligning a timing of selective nozzle jetting of respective heads with anticipated positioning of respective drop positions on a surface; and
selectively jetting, for each respective nozzle, to the respective drop positions on the surface, in accordance with the schedule data.

25. The method of claim 24, wherein the schedule data includes selective jetting frequencies for each respective nozzle in a respective head.

26. The method of claim 24, wherein the aligning of the timing of selective nozzle jetting includes different nozzles in different heads operating at different times.

27. The method of claim 24, wherein the aligning of the timing includes taking into consideration movement between the surface and the head array.

28. The method of claim 27, wherein the movement between the surface and the head array is with the head array being aligned in an orientation without an inclination relative to a pitch between drop positions.

29. The method of claim 27, wherein the movement is a movement of the surface past a fixed position of the head array, at a predetermined velocity.

30. The method of claim 24, further comprising generating a jet control signal for each head corresponding to the schedule data to control jetting of each respective head.

31. The method of claim 30, wherein the generating of the jet control signal for each head comprises utilizing separate schedule data for each respective head.

32. The method of claim 24, further comprising receiving the schedule data from a storage unit.

33. The method of claim 24, wherein the plurality of heads jet ink drops in the lengthwise direction of color filter cells of the surface.

34. The method of claim 24, wherein:
the schedule data is based on positions of respective nozzles of respective heads of the head array and corresponding drop positions for corresponding color filter cells on a glass substrate, as the surface, and
the schedule data is processed by one head driver to generate ink-jet control signals for each respective head to control jetting of ink for each respective head.

35. The method of claim 34, wherein each respective head jets ink from a starting jet position for a first corresponding head to a jet position, for a color filter cell, where a second corresponding head neighboring the corresponding first head previously started jetting an ink drop.

36. The method of claim 35, wherein at least five drops are jetted within each color filter cell.

37. The method of claim 36, wherein first heads provided having drop positions aligned with respective nozzles of the first heads, among drop positions on the surface for corresponding color filter cells, simultaneously jet.

38. The method of claim 37, wherein second head, not simultaneously jetting with the first heads, delay corresponding simultaneous jetting until the second heads are transferred, through movement of the head array or surface, as far as a distance gap between a corresponding nozzle of a second head and an alignment with a next corresponding drop position on the surface nearest to the corresponding nozzle of the second head.

39. The method of claim 38, wherein each second head first jets to a drop position that is separated from the next corresponding nearest drop position according to a pitch for drop positions, when a delay for a corresponding distance gap is smaller than a period to receive corresponding schedule data for generating an ink-jet control signal of each head to control jetting of each head.

40. The method of claim 24, wherein:
the head array comprises a set of arrays of heads for separate color filter cells for a first color, a second color, and a third color, respectively, and
heads for each respective array, for each color filter cell, jet in accordance with a corresponding ink-jet control signal.

41. The method of claim 40, wherein:
the first color is red (R), the second color is green (G), and the third color is blue (B), and
the color filer cells for each color are printed in a stripe having a same consistent color in a lengthwise direction of each cell.

42. The method of claim 40, wherein:
the first color is red (R), the second color is green (G), and the third color is blue (B), and
the color filter cells for each color are printed in a triangle arrangement.

43. The method of claim 24, wherein each of the plurality of schedule data is processed by each of the plurality of head drivers and the ink-jet control signal of each head is generated.

44. The method of claim 43, wherein:
heads, having nozzles aligned with drop positions, simultaneously jet ink drops to respective drop positions for color filter cells on a glass substrate, as the surface, and
heads, having nozzles not aligned with drop positions, simultaneously jet ink to a respective next jet position after being first transferred a distance gap between a corresponding nozzle and the respective next jet position nearest to the corresponding nozzle, on the glass substrate.

45. A medium comprising computer readable code to implement the method of claim 24.
